(19) United States
(12) Patent Application Publication
(10) Pub. No.: US 2006/0231968 A1
(43) Pub. Date: Oct. 19, 2006

(54) Protein-modified isocyanate-functional adhesive binder for cellulosic composite materials

(75) Inventors: Jennifer Cowan, Atlanta, GA (US); Derek L. Atkinson, Atlanta, GA (US); Robert A. Breyer, Tucker, GA (US); Jason D. Rivers, Monroe, GA (US); Charles E. Vest JR., Loganville, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 11/104,409

(22) Filed: Apr. 13, 2005

(51) Int. Cl. B27N 3/00

(52) U.S. Cl. 264/109; 524/13; 527/103; 156/331.4

(57) ABSTRACT

An adhesive binder composition containing an isocyanate-functional resin modified with a protein, preferably with a source of soy protein, and the use of the binder for preparing wood composites, especially OSB.

### FIELD OF THE INVENTION

This invention relates generally to an adhesive binder composition for cellulosic composite materials. More specifically, the invention relates to an isocyanate-functional adhesive binder containing a protein component. The adhesive binder composition is suitable for forming wood composites, such as oriented strand board (OSB). The invention also relates to composite wood products made with the adhesive binder composition, and to the process for making the composite wood product.

### BACKGROUND OF THE INVENTION

Composite wood products have found great favor in various industries. Whether bonded or laminated, composite wood products often exhibit superior properties to wood of similar dimensions. Composite products often are stronger, exhibit better resistance to degradation and failure, and are more cost-effective than wood alone.

Divers composite wood products have gained acceptance. Plywood, particle board, fiber board, laminated products such as laminated veneer lumber and laminated beams, and OSB are but a few of the composite wood products that have become widely accepted in industry. Such products are formed from wood pieces of appropriate size and form. These wood pieces are bonded together with an adhesive to form the composite wood product.

Because wood is porous and can have varying moisture content, an adhesive should be able to penetrate the wood to a degree sufficient to form the desired bond while accommodating the moisture content of the wood. The various varieties of wood have various grain structures that also affect the ability to bond the wood with adhesive. Thus, the adhesive must not only penetrate the wood, but also dry in an appropriate period. Drying too quickly will limit wood penetration and ability to re-position the wood pieces, if necessary. Drying too slowly will cause production delays and thus increase cost.

To accommodate these variations and provide adhesives that have properties and characteristics preferred by users, various adhesive systems have been developed. Typically, the adhesive is selected to accommodate not only the type of wood and the type of wood pieces to be bonded, but also the use to which the composite is to be put. For example, composite to be used out of doors or that will be exposed to water has different adhesive requirement than a composite that is to be used in a dry location. Suitable adhesive also should fill any gaps between wood pieces during curing. Adhesive also should have a viscosity that enables rapid application with typical processing equipment.

The ability to form a shape-retaining ‘green’ product, composite product in which the adhesive has not yet cured, also is important. This ability allows quick and efficient production of cured composite wood product. Shape-retaining green board can be formed by using an adhesive that has sufficient ‘tack,’ i.e., the ability to retain the shape of the product without completely curing. Tack enables more rapid processing of composite product because adhered particles tend to stick together, rather than move individually. This property enables a manufacturer to remove green board from a shape-retaining container before the adhesive is fully cured, thus enabling more rapid production than with an adhesive that does not exhibit tack. An adhesive that has tack before complete curing also is advantageous because it allows re-arrangement of the wood pieces relative to each other while essentially retaining the form originally imparted. This property allows the wood pieces to pack more efficiently, for example, or to be re-positioned before complete curing of the adhesive.

Isocyanate-functional adhesives are used in the production of OSB and other forms of composite wood product. Isocyanate-functional adhesives are particularly resistant to water, and therefore are especially useful in manufacture of exterior products or products intended for exposure to water. However, isocyanate-functional adhesives are not completely satisfactory for high-speed production of composite wood products. Such adhesives have essentially no tack, and so slow production significantly because the green board must be kept in a shape-retaining container for a longer period. Such adhesives also contain chemicals that some find objectionable because, for example, they are derived from petroleum, release objectionable fumes into the environment, or are otherwise objectionable. Also, the components can be relatively expensive.

Adhesives made from protein products, such as vegetable powder or flour, are known to skilled practitioners. Wheat- and corn-based products are but examples of such products. Proteins from animals also have been used as adhesives. However, composite products made with such adhesives typically must be kept dry, and are not suitable for uses that will bring the composite into contact with water. Such adhesives are considered environmentally friendly, however, because they are made from a renewable resource.

Adhesives made from soy protein products, particularly hydrolyzed soy protein, are known. However, soy protein hydrolyzate adhesive is unsatisfactory for a number of reasons. It is viscous and dries quickly, often before suitable bonds can be made with the wood. Thus, composite wood products made with soy protein hydrolyzate adhesive often have low strength.

Other types of modified soy protein adhesives are disclosed in U.S. Pat. No. 6,497,760. These adhesives are said to provide increased shear strength compared to hydrolyzed soy protein adhesive. However, these adhesives dry quickly, and so impart only minimal bonding strength to composite wood products.

U.S. Pat. No. 6,365,650 discloses an isocyanate-functional adhesive modified with soy protein hydrolyzate for adhering two pieces of wood with a finger joint, such as for parallel laminated veneers. The adhesive is modified with hydrolyzed soy protein.

Even in view of these disclosures, there exists a continuing need for a new adhesive for composite wood products. In particular, an adhesive that has good tack is desired, as it affords the opportunity to shorten processing time. Shortened processing time is valuable to composite wood product manufacturers. Further, such a new adhesive should be environmentally friendly, cost-effective, and provide water-resistance.

### BRIEF SUMMARY OF THE INVENTION

The invention is directed to a protein-modified isocyanate-functional adhesive binder for forming composite wood products. The adhesive binder comprises protein, preferably vegetable protein. The invention also is directed to use of the adhesive binder as a component of a composite wood product, to a process for making the composite wood products, particularly OSB, using the adhesive binder, and to composite wood products produced by the process.

### DETAILED DESCRIPTION OF THE INVENTION

The invention is based on the discovery that modification of an isocyanate-functional resin with vegetable protein yields an adhesive binder that is less expensive than unmodified isocyanate-functional adhesive, yet provides superior bonding. Modified adhesive binder of the invention also provides superior tack as compared with unmodified isocyanate-functional adhesive resin, thus providing green board that retains its shape more quickly than green board made with unmodified adhesive. Thus, the production rate of composite boards, such as OSB, can be increased by use of adhesive binder of the invention. Composite products made with adhesive binder of the invention exhibit bond strength between about 4 and about 10 percent higher than bond strength of comparable composite product made with unmodified isocyanate-functional resin. Skilled practitioners recognize that there exist many ways of measuring bond strength. For example, internal bond strength can be measured by pulling the composite apart in a direction perpendicular to the plane formed by the test piece. A standard method for determining internal bond strength is ASTM D1037-99.

Adhesive binder of the invention is an isocyanate-functional adhesive resin modified with soy protein. Isocyanate-functional adhesive resins are known to skilled practitioners and are available commercially. Any form of isocyanate-functional resin that can react with the other reactants and that does not introduce into the adhesive moieties deleterious to the desired reactions and to the reaction product can be used in preparation of the modified adhesive binder of the invention.

Reactants used to form isocyanate-functional resin are known as isocyanate-functional prepolymers, i.e., materials that are reacted together to form an isocyanate-functional resin, i.e., a urethane. Isocyanate-functional prepolymers are made from poly-isocyanates reacted with a compound containing active hydrogen functionality. Moieties that provide active hydrogen functionality include hydroxyl groups, mercaptan groups, amine groups, and carboxyl groups. Hydroxyl groups are most typically used. The present invention is not limited to a specific isocyanate-functional adhesive.

Polyisocyanates are conventional in nature and include, for example, hexamethylene diisocyanate, toluene diisocyanate (TDI), diphenylmethane diisocyanate (MDI), m- and p-phenylene diisocyanates, bitolylene diisocyanate, cyclohexane diisocyanate (CHDI), bis-(isocyanatomethyl) cyclohexane (H₆XDI), dicyclohexylmethane diisocyanate (H₁₂MDI), dimer acid diisocyanate (DDI), trimethyl hexamethylene diisocyanate, lysine diisocyanate and its methyl ester, methyl cyclohexane diisocyanate, 1,5-napthalene diisocyanate, xylylene and xylene diisocyanate and methyl derivatives thereof, polymethylene polyphenyl isocyanates, chlorophenylene-2,4-diisocyanate, polyphenylene diisocyanates available commercially as, for example, Mondur MR or Mondur MRS, isophorone diisocyanate (IPDI), hydrogenated methylene diphenyl isocyanate (HMDI), tetramethyl xylene diisocyanate (TMXDI), hexamethylene diisocyanate (HDI), or oligomer materials of these materials such as a trimer of IPDI, HDI or a biuret of HDI, and the like, and mixtures thereof. Triisocyanates and high-functional isocyanates also are well known and can be used to advantage. Aromatic and aliphatic diisocyanates, for example, (including biuret and isocyanurate derivatives) often are available as pre-formed commercial packages and can be used to advantage in the present invention.

Preferred polyols for reacting with the polyisocyanates include, for example, polyether polyols (e.g., block polyethylene and polypropylene oxide homo- and co-polymers ranging in molecular weight from about 300 to about 3,000) optionally alkylated (e.g., polytetramethylene ether glycols), caprolactone-based polyols, and the like. However, the component also may be formulated with mixtures of aliphatic and aromatic polyols, or a multi-functional, active hydrogen-bearing polymer. Thus, in addition to polyether polyols, the hydroxyl-functional component may include derivatives of acrylates, esters, vinyls, and castor oils, as well as polymers and mixtures thereof.

Isocyanate equivalents should predominate over active hydrogen equivalents in the polyisocyanate/polyol reaction mixture in order for the resulting prepolymer to contain residual isocyanate groups. Reaction conditions for this reaction are well known in the art, such as described by Heiss, et al., “Influence of Acids and Bases on Preparation of Urethane Polymers,” Industrial and Engineering Chemistry, Vol. 51, No. 8, August 1959, pp. 929-934. Depending upon the reaction conditions used (such as, for example, temperature and the presence of strong acids or bases, and catalysts), the reaction may lead to the formation of ureas, allophanates, biurets, or isocyanates.

Skilled practitioners recognize that catalyst can be used to accelerate the rate of reaction of the isocyanate-functional prepolymers. Typical catalysts include, for example, dibutyl tin dilaurate. Similarly, inhibitors can be used to retard the cross-linking reaction. Such inhibitors include, for example, benzoyl chloride and monophenyldichlorophosphate. These and other additives known to skilled practitioners can be used in the binder composition of the invention.

Polymeric isocyanate-functional resins are commercially available from various supplies. One such resin is Rubinate® 1840, available from Huntsman Chemical. Polymeric MDI-based resin also is identified as pMDI resins or MDI resins, and these terms often are used interchangeably when referring to such resins.

The second component of the modified isocyanate-functional adhesive binder composition of this invention is a protein. The invention is based on the discovery that adding an effective, binding-enhancing amount of a soy protein, to any thermosetting isocyanate-functional adhesive resin tailored for making a wood composite adhesive binder yields wood composites made with that adhesive that has improved internal bond strengths.

Soy protein is preferred in the practice of the invention. Both raw soy protein and soy protein modified in accordance with the disclosure of U.S. Pat. No. 6,497,760, the entirety of which is hereby incorporated by reference, are suitably used in the invention. This modified soy protein is especially preferred.

Raw soy protein can be in the form of ground whole beans (including the hulls, oil, protein, minerals, etc.), a meal (extracted or partially extracted), a flour (i.e., generally containing less than about 1.5% oil and about 30-35% carbohydrate), or an isolate (i.e., a substantially pure protein flour containing less than about 0.5% oil and less than about 5% carbohydrate). As used herein in the specification and claims, “flour” includes within its scope material that fits both the definitions of flour and isolate. However, hydrolyzed soy protein is not included within the definition of raw soy protein.

Any source of soy protein (such as soybean concentrate or soybean meal) is suitable for use as the binder modifier in the present invention. Protein-rich soybean-derived flours, such as soy protein isolate, protein concentrate and ordinary defatted soy flour, which contain in the range of about 20-95% protein, should each be suitable. Of these, ordinary soy flour is the most abundant and cost-effective. The source of soy protein (soy flour) is preferably essentially free of functional urease. Information on soy protein can be found in, for example, Kirk-Othmer, Encyclopedia of Chemical Technology, Fourth Edition, Volume 22, pp. 591-619 (1997).

Preferably, the protein is in the form of a protein flour, at least because the adhesive binder and related wood composite products produced from the binder made with a flour, as opposed to a meal, are expected to have more desirable physical properties.

Preferably, the protein has a particle size (as determined by the largest dimension) of less than about 0.1 inch (0.25 cm), and more preferably less than about 0.05 inch (0.125 cm). If the particle size is much larger than this, the protein material may not be sufficiently soluble or dispersible to produce an adhesive binder suitable for making wood composites with optimum properties. In those embodiments where the protein is blended with the resin before application to the wood particles, the time required to solubilize the material tends to be undesirably longer with larger particles.

A protein flour is more preferred because of its generally smaller particle size distribution. That is, the most preferred ground vegetable protein has a maximum particle size of that of a flour, i.e., about 0.005 inch (0.013 cm). There does not appear to be a minimum particle size requirement for the ground vegetable protein; however, the particle size of commercially available soybean flour is generally less than about 0.003 inch (0.008 cm). For example, in some commercially available soybean flour, greater than about 92% passes through a 325 mesh screen, which corresponds to a particle size of less than about 0.003 inch (0.008 cm). Thus, a wide range of soy flours are expected to be suitable, such as a flour having at least 90 to 95% of its particles smaller than 100 mesh, smaller than 200 mesh, or smaller than 400 mesh.

A particularly preferred type of protein is soy protein modified in accordance with U.S. Pat. No. 6,497,760, the entirety of which is hereby incorporated by reference. These soy proteins are modified with either of two classes of modifiers. The first class of modifiers includes saturated and unsaturated alkali metal C₈-C₂₂ sulfate and sulfonate salts. Two preferred modifiers in this class are sodium dodecyl sulfate and sodium dodecylbenzene sulfonate. The second class of modifiers includes compounds having the formula R₂NC(═X)NR₂, wherein each R is individually selected from the group consisting of H and C₁-C₄ saturated and unsaturated groups, and X is selected from the group consisting of O, NH, and S. The C₁-C₄ saturated groups refer to alkyl groups (both straight and branched chain) and the unsaturated groups refer to alkenyl and alkynyl groups (both straight and branched chain). The preferred modifiers in this class are urea and guanidine hydrochloride. Modified soy protein used in the invention and a method for making the modified soy protein are described in U.S. Pat. No. 6,497,760, the entirety of which is hereby incorporated by reference. Blends of soy protein types also are used to prepare adhesive binder of the invention.

The modified soy protein is a powder. Typically, 90 percent of the particles pass through a 50 mesh screen. However, finer powders, such as powders wherein 90 percent of the particles pass through a finer screen, such as a 100 mesh, 150 mesh, or 200 mesh screens, also are suitable for use in the adhesive binder of the invention. Typically, modified soy protein can be suspended in water to form a suspension having as much as about 30 wt percent solids.

Both soy protein and modified protein form an aqueous suspension. Soy protein suspension typically has a solids concentration of up to about 25 wt. percent; modified soy protein forms a suspension of up to about 30 wt. percent. However, as skilled practitioners recognize, the isocyanate-functional adhesive will react with water and form a gel. Therefore, an aqueous suspension of soy protein is not preferred in the practice of the invention. If an aqueous soy suspension is used, the binder must be used essentially immediately or a gel will form.

Adhesive binder of the invention is made by mixing the isocyanate-functional resin, or prepolymers used to form isocyanate-functional resin, with the soy protein component. Such mixing can be carried out in accordance with known methods for making the isocyanate-functional portion of the adhesive and with known techniques.

Adhesive binder of the invention preferably is made by mixing the components and reacting them to incorporate the protein in the isocyanate-functional resin to form the adhesive binder. Soy protein is incorporated into the isocyanate-functional resin by mixing the protein into prepolymer before final reaction, or into either of the components thereof. The components then are reacted to form adhesive binder of the invention. The mixing of the isocyanate-functional resin and the protein will cause a reaction between the components that will form a gel. Therefore, adhesive binder of the invention preferably is used within about 10 minutes, more preferably within about 5 minutes, and most preferably within about 1 minute from when the components are combined. As set forth above, if the protein component is in the form of an aqueous suspension, the adhesive binder preferably is used immediately. Most preferably, soy protein is added to prepolymer immediately before use of the adhesive binder. In this way, the likelihood of adverse reactions (gellation or premature cross-linking) is minimized.

Adhesive binder of the invention also can be formed in situ. In accordance with this embodiment of the invention, the isocyanate-functional prepolymers or resin and the protein are separately added to a blender and mixed with the wood particles to be bonded.

In one embodiment of the invention, modified soy protein is used to form adhesive binder that exhibits water resistance sufficient for use in applications where water can come into contact with composite product made with the adhesive binder. Composite products for outdoor use (“exterior grade”) are examples of such products requiring water resistance.

Skilled practitioners recognize that water resistance can be measured in various ways, e.g., by immersion testing or by exposure to a high-humidity atmosphere. The inventors utilize a test wherein a 2′×2′ specimen having a known internal bond strength is immersed in boiling water for 2 hours, then dried for 24 hours at 180° F. The internal bond strength after boiling (“BIB”) is determined after the drying period. The inventors have found that this test, which is a measure of external durability, yields results comparable to other external durability tests know to skilled practitioners.

Water resistance also can be characterized in terms of board thickness swell or water absorption after a period of immersion. However, these methods are not quantitative determinations, and products that are not considered water resistant in accordance with the BIB test sometimes exhibit properties similar to water-resistant products.

Skilled practitioners recognize that isocyanate-functional resins are resistant to water, and that protein-based resins typically exhibit little to no resistance to water. However, the inventors have discovered that substitution of an isocyanate-functional resin with up to 30 wt. percent modified soy protein isocyanate resin does not adversely affect the water resistance of the modified adhesive binder. Thus, the modified adhesive binder of this embodiment is suitably used in applications that require water resistance.

In accordance with this embodiment of the claimed invention, water-resistant adhesive binder of the invention can be prepared by including an amount of modified soy protein to provide, on a solids basis, a weight ratio of urethane solids to protein solids (U:Protein) of between about 99.9:0.1 and about 70:30, preferably between about 95:5 and about 75:25, and most preferably between about 90:10 and about 80:20.

In another embodiment, adhesive binder of the invention is not considered water-resistant for commercial purposes. In accordance with this embodiment of the invention, adhesive binder for the invention that is not water resistant can be prepared by including an amount of modified soy protein to provide, on a solids basis, a U:Protein ratio between about 70:30 and about 20:80, or by including an amount of raw soy protein to provide, on a solids basis, a U:Protein ratio of between about 99.5:0.5 and about 20:80. With either soy protein source, the U:Protein ratio for this embodiment preferably is between about 65:35 and about 20:80, and more preferably between about 60:40 and about 40:60.

The total concentration of non-volatile components in the adhesive binder composition preferably will be essentially 100 percent. Both types of soy protein are essentially 100 percent solids, as are the various isocyanate-functional resins. If an aqueous suspension of protein is used, the water will reduce the solids content of the resin. However, as set forth above, use of an aqueous suspension of protein is not preferred.

The adhesive binder composition may also contain a variety of other known additives such as, for example, silica to enhance fire resistance, wax to enhance water resistance, antifoamers, lubricants, plasticizers, softening agents, pigments, biocides, fillers, and the like, normally in small proportions relative to the required urethane and protein constituents.

The amount of adhesive binder applied to the wood pieces also can vary considerably in the broad practice of the present invention, but loadings in the range of about 1 to about 45 percent by weight, preferably about 4 to about 30 percent by weight, and more usually about 5 to about 20 percent by weight, of nonvolatile modified adhesive binder composition based on the dry weight of the wood pieces, will be found advantageous in preparing most wood composite products such as particle board and medium density fiberboard (MDF). For OSB, typical adhesive binder loadings are between about 1 and about 4 percent by weight, preferably about 1.2 to about 3 percent by weight, and more preferably about 1.5 to about 2.5 percent by weight, of non-volatile modified adhesive binder composition, based on the dry weight of the wood pieces. In the case of making plywood, the level of adhesive usage in generally expressed as glue spreads. Glue spreads in the range of 50 lbs to 110 lbs of adhesive per 1000 square feet of glue line, when the veneer is spread on both sides, or in the range of 25 lbs to 55 lbs, when the glue is spread on only one side of the veneer are normally used for making plywood.

Wood composites such as oriented strand board, particleboard, flake board, medium density fiberboard, waferboard, and the like are generally produced by applying the adhesive binder to the wood pieces, such as by blending or spraying the processed lignocellulose materials (wood pieces) such as wood flakes, wood fibers, wood particles, wood wafers, wood strips, wood strands, or other comminuted lignocellulose materials with an adhesive binder composition while the materials are tumbled or agitated in a blender or equivalent apparatus. When making plywood, the adhesive binder can be applied to the veneers by roll coater, curtain coater, spray booth, foam extruder and the like.

After applying and/or blending the adhesive binder and lignocellulose materials sufficiently to form a substantially uniform mixture, the wood pieces are formed into a loose mat, which then is generally compressed between heated platens or plates to set (cure) the adhesive and bond the flakes, strands, strips, pieces, and the like, together in densified form. Conventional pressing processes are generally carried out at temperatures of from about 120 to 225° C. in the presence of varying amounts of steam generated by liberation of entrained moisture from the wood or lignocellulose materials. Some processes use a combination of press curing with hot platens and heat generated by radio frequency. This combination may permit rapid curing with a reduced press time. Plywood is prepared by assembling the wood veneers into panels and consolidating the panels under heat and pressure. This is usually done in a steam hot-press using platen temperatures of 115° to 180° C. and pressures of 75 to 250 psi.

In these processes, the moisture content of the lignocellulose material is usually between about 2 and about 20% by weight, before it is blended with the aqueous adhesive binder. One exception is medium density fiberboard, where the adhesive resin typically is applied to the green (un-dried) wood fiber and then passed through a dryer.

For example, when manufacturing OSB, the modified isocyanate-functional adhesive binder is sprayed onto the wood particles generally in an amount of from about 1 to about 4 parts of non-volatile adhesive binder solids per 100 parts of dry wood. The resin-treated wood particles are then formed into a mat, and compacted in a hot press to the desired density. OSB panels are usually made to have a density in the range from about 35 to about 46 lbs/ft³. Typically, the thickness of OSB falls in the range from about one-eighth inch to two inches.

Skilled practitioners recognize that composite products can be manufactured with multiple adhesive systems, and are familiar with methods for manufacturing such products. For example, for OSB, different adhesives can be used for the core and for the faces. This technique can be utilized with the invention by, for example, using different proportions of modified soy protein in the core adhesive from that used in the face adhesive. In this way, the properties and characteristics of the OSB product can be adjusted. Similarly, particleboard can be made in the same way.

In addition to the mat-forming hot pressing process, wood composite products from small wood pieces also have been made using an extrusion process. In this process, a mixture of the wood particles, adhesive, and other additives is forced through a die to make a flat board. The present invention is not limited to any particular way of making the wood composites.

The adhesive binder composition of the invention sets or cures at elevated temperatures below the decomposition temperature of the urethane and protein components. The setting or curing of the adhesive binder composition normally can occur at temperatures from about 100° C. to about 300° C., preferably from about 100° C. to about 275° C. At these temperatures, the adhesive binder composition typically will cure in periods ranging from a few seconds to several minutes or more. Although the adhesive binder may cure more rapidly at higher temperatures, excessively high temperatures can cause deterioration of the adhesive composition, which in turn may cause a deterioration of the physical and functional properties of the wood composite. Of course, lower temperatures and/or longer times can also be employed if desired.

The present invention is not limited to any particular process for uniting the adhesive binder with the wood material, or for consolidating the adhesive-treated wood into a coherent, cured product.

As used herein, “curing,” “cured” and similar terms are intended to embrace the structural and/or morphological change which occurs in the adhesive of the present invention as it is heated to cause covalent chemical reaction, ionic interaction or clustering, improved adhesion to the substrate, phase transformation or inversion, and hydrogen bonding.

A surprising benefit of the protein addition in addition to the improved internal bond strength was the enhanced tack of the protein-modified adhesive binder. Skilled practitioners recognize that isocyanate resins typically exhibit no tack. The protein-modified adhesive binder not only has tack sufficient to yield forms that tend to retain their shape before curing, but also tended to retain the tack for a longer period of time than the control resin made without the soy protein. The tack of the protein-modified adhesive binder of the invention has about the same tack as a urea/formaldehyde resin.

### EXAMPLE 1

Boards were made with the seven resin systems described in Table 1, as follows:

TABLE 1

| | Composition, wt % | | | |
|---|---|---|---|---|
| Resin | UF | Modified Soy Flour | Raw Soy Flour | pMDI |
| 1 | 100 | | | |
| 2 | | 20 | | 80 |
| 3 | | | 20 | 80 |
| 4 | | 50 | | 50 |
| 5 | | | 50 | 50 |
| 6 | | | 80 | 20 |
| 7 | | | | 100 |

The UF resin was a resin commercially available from G-P Resins Inc. under the tradename 670D22. The resin had a molar U/F ratio of 1.75. The raw soy flour was Cargill PDI 90/100 having a particle size of 100 microns.

The pMDI resin was Rubinate® 1840 from Huntsman Chemical.

Particleboard was made at two press times—240 and 330 seconds. The press temperature was 330° F., and the press profile was as follows: 60 seconds from closing to 600 psi; the variable press time at 300 psi; then 10 seconds at 50 psi, with pressure released thereafter.

Resin and face furnish having a moisture content of 5.7% were blended in a tumble blender.

Board was made with 8 grams resin per 100 grams wood, and at a target density of 48 lbs/ft³.

The boards thus formed were tested to determine internal bond strength (IB), percent water absorption over a 24-hour period, and swell due to water absorption. A number of determinations were carried out on each board. Internal Board Strength (IB) was measured on a 2′×2′ specimen in accordance with ASTM D1037-99. Water absorption was determined by measuring the weight of a 6′×6′ sample before and after soaking the sample in 25° C. water for 24 hours, also in accordance with ASTM D1037-99. Swell due to water absorption was determined by measuring the thickness of the board before and after the water absorption test.

Table 2 summarizes the properties and characteristics measured:

TABLE 2

| | | | | Thickness |
|---|---|---|---|---|
| Resin | Press Time, sec | IB, psi | Water Absorbed, % | Swell, % |
| 1 | 240 | 76 | 91 | 24 |
| | 330 | 78 | 87 | 26 |
| 2 | 240 | 296 | 71 | 13 |
| | 330 | 304 | 78 | 13 |
| 3 | 240 | 367 | 68 | 13 |
| | 330 | 307 | 65 | 13 |
| 4 | 240 | 310 | 63 | 16 |
| | 330 | 296 | 78 | 15 |
| 5 | 240 | 250 | 60 | 16 |
| | 330 | 240 | 68 | 16 |
| 6 | 240 | 139 | 82 | 26 |
| | 330 | 122 | 87 | 25 |
| 7 | 240 | 340 | 62 | 12 |
| | 330 | 406 | 65 | 12 |

The data indicates that particleboard made from soy/pMDI blends of the invention had properties and characteristics comparable to the properties and characteristics of particleboard made with urea/formaldehyde resin.

### EXAMPLE 2

OSB panels 7/16′ thick were made using pine wood flakes and a pMDI-based adhesive in accordance with the following table:

TABLE 3

| | Composition, wt % | | |
|---|---|---|---|
| Resin | pMDI | Modified Soy Flour | Raw Soy Flour |
| 11 | 100 | | |
| 12 | 90 | 10 | |
| 13 | 90 | | 10 |
| 14 | 80 | 20 | |
| 15 | 80 | | 20 |
| 16 | 70 | 30 | |
| 17 | 70 | | 30 |

The MDI was Rubinate® 1840, available from Huntsman Chemical.

The wood flakes were 3′ southern yellow pine flakes dried to 6.1% moisture content. The wood flakes were coated with slack wax at 1 lb. wax/100 lbs wood flakes. Dry soy flour was mixed with the coated flakes in a blender. Then, pMDI was sprayed onto the content of the mixer.

Panels 16′ square were made with a target density of 43 lbs/ft^{3.} The panels were pressed at 400° F. for 2.25 minutes, with a target close time of 30 second.

The panels were tested to determine internal bond strength (IB), boiled internal bond strength (BIB), water absorption (WA), thickness swell (TS), and edge thickness swell (ETS). These data are reported in Table 4:

TABLE 4

| Resin | IB, psi | BIB, psi | WA, % | TS, % | ETS, % |
|---|---|---|---|---|---|
| 11 | 96 | 55 | 17.2 | 8.0 | 18.8 |
| 12 | 111 | 48 | 17.9 | 8.5 | 19.3 |
| 13 | 101 | 42 | 20.2 | 8.9 | 18.8 |
| 14 | 139 | 51 | 19.5 | 8.8 | 18.3 |
| 15 | 112 | 26 | 18.2 | 9.1 | 18.3 |
| 16 | 100 | 27 | 21.0 | 10.3 | 20.5 |
| 17 | 124 | 30 | 18.2 | 9.1 | 18.3 |

As can be seen from the data summarized in Table 4, there was no adverse effect on IB for each concentration of soy flour and soy type exemplified. The IB data for modified soy flour resins shows an increase from 0 to 20 wt % modified soy flour substitution. However, at 30 wt % modified soy, the IB value drops to a value similar to that for unmodified MDI resin. The inventors believe that this result was anomalous. The IB values for soy flour resins increase with increased soy concentration, but are lower than IB values for 10 and 20 wt % substitution levels.

The BIB values for board made with resins having as much as 20 wt % modified soy flour (Resins 12 and 14) showed good water resistance. However, the BIB for board made with resin comprising 30 wt % modified soy flour was unexpectedly low. This is believed to be due to the anomalously low IB for this board.

WA increased with increasing modified soy flour. Although the inventors do not wish to be bound by theory, it is believed that the nature of the modification of the soy flour to be a cause of this phenomenon because the modification makes the modified soy flour more water-soluble. Although various differences exist between resins, however, the differences found in this parameter were not significant.

Thickness swell increased with increased soy concentration for modified soy flour, whereas soy flour showed essentially constant TS. The TS for boards made from soy-containing resins illustrates that an acceptable product having essentially the same TS as boards made using unmodified MDI resin were made with both modified and unmodified soy flour.

Edge thickness swell data illustrates generally that the concentration of soy, whether modified or unmodified, does not have an adverse effect on ETS. The sole exception to this statement is 30% modified soy flour, for which the ETS increased somewhat. However, these data illustrate that soy flour, whether modified or raw, did not adversely affect the product.

The inventors investigated whether product characteristics were adversely affected because the boards had differing density, especially at 30 wt % modified soy flour. However, there was no strong relationship between IB and board density.

Thus, as can be seen in the data, replacement of pMDI resin with up to about 30% modified soy has essentially no adverse effect on the water-resistance. Also, replacement at greater concentration yielded a composite product that had good properties but lacked equivalent water resistance.

While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims. For example, the invention can be used to form other wood composite articles other than those exemplified herein. Unless otherwise specifically indicated, all percentages are by weight. Throughout the specification and in the claims the term “about” is intended to encompass + or −5%.

We claim:

1. A wood composite bonded with an adhesive binder composition comprising an isocyanate-functional resin modified with a soy protein selected from the group consisting of soy flour, soy protein modified with saturated and unsaturated alkali metal C₈-C₂₂ sulfate and sulfonate salts, soy protein modified with compounds having the formula R₂NC(═X)NR₂, wherein each R is individually selected from the group consisting of H and C₁-C₄ saturated and unsaturated groups, and X is selected from the group consisting of O, NH, and S, and blends thereof, said protein provided in an amount of about 0.5 to about 80 percent by weight of binder solids.

2. The wood composite of claim 1 wherein the soy protein is soy flour.

3. The wood composite of claim 1 wherein the soy protein is selected from the group consisting of soy protein modified with saturated and unsaturated alkali metal C₈-C₂₂ sulfate and sulfonate salts, soy protein modified with compounds having the formula R₂NC(═X)NR₂, wherein each R is individually selected from the group consisting of H and C₁-C₄ saturated and unsaturated groups, and X is selected from the group consisting of O, NH, and S, and blends thereof.

4. The wood composite of claim 3 made using a wood source selected from wood flakes, wood fibers, wood particles, wood wafers, wood strips, wood strands, and wood veneer.

5. The wood composite of claim 3 wherein the protein is provided in an amount of 0.5 to about 30 percent by weight of the binder solids and the wood composite is water resistant.

6. The wood composite of claim I wherein the isocyanate-functional resin is synthesized with an excess of isocyanate.

7. The wood composite of claim 1 wherein said protein is provided in an amount of about 20% to about 70% by weight of binder solids.

8. A process for making a wood composite comprising applying an adhesive binder composition to a wood material, the adhesive binder composition comprising an isocyanate-functional resin modified with a soy protein selected from the group consisting of soy flour, soy protein modified with saturated and unsaturated alkali metal C₈-C₂₂ sulfate and sulfonate salts, soy protein modified with compounds having the formula R₂NC(═X)NR₂, wherein each R is individually selected from the group consisting of H and C₁-C₄ saturated and unsaturated groups, and X is selected from the group consisting of O, NH, and S, and blends thereof, said protein provided in an amount of about 0.5 to about 80 percent by weight of binder solids, consolidating said wood material, and curing said isocyanate-functional resin.

9. The process of claim 8 wherein the protein is soy flour.

10. The process of claim 8 wherein the soy protein is selected from the group consisting of soy protein modified with saturated and unsaturated alkali metal C₈-C₂₂ sulfate and sulfonate salts, soy protein modified with compounds having the formula R₂NC(═X)NR₂, wherein each R is individually selected from the group consisting of H and C₁-C₄ saturated and unsaturated groups, and X is selected from the group consisting of O, NH, and S, and blends thereof.

11. The wood composite of claim 10 wherein the protein is provided in an amount of 0.5 to about 30 percent by weight of the binder solids and the wood composite is water resistant.

12. The process of claim 8 wherein the wood material is selected from wood flakes, wood fibers, wood particles, wood wafers, wood strips, wood strands, and wood veneer.

13. The process of claim 8 wherein the isocyanate-functional resin is synthesized with an excess of isocyanate.

14. The process of claim 8 said protein is provided in an amount of about 20% to about 70% by weight of binder solids.

15. An adhesive binder comprising an isocyanate-functional resin modified with a soy protein selected from the group consisting of soy flour, soy protein modified with saturated and unsaturated alkali metal C₈-C₂₂ sulfate and sulfonate salts, soy protein modified with compounds having the formula R₂NC(═X)NR₂, wherein each R is individually selected from the group consisting of H and C₁-C₄ saturated and unsaturated groups, and X is selected from the group consisting of O, NH, and S, and blends thereof, said protein provided in an amount sufficient to form an adhesive binder having greater strength than the isocyanate-functional resin.

16. The binder of claim 15 wherein the strength increase is at least about 4%.

17. The binder of claim 15 wherein the protein is soy protein is provided in an amount between about 20 and about 70 percent of binder solids.
